(19) United States
(12) Patent Application Publication
(10) Pub. No.: US 2007/0207055 A1
(43) Pub. Date: Sep. 6, 2007

(54) Operating Device Comprising A Localized Zone For The Capture Of A Drop A Liquid Of Interest

(75) Inventors: Gilles Marchand, Pierre Chatel (FR); Cyril Delattre, Izeaux (FR); Patrick Pouteau, Meylan (FR); Patrice Caillat, Grenoble (FR)

Correspondence Address: MCKENNA LONG & ALDRIDGE LLP, 1900 K STREET, NW, WASHINGTON, DC, 20006, US

(73) Assignee: Commissariat A L'Energie Atomique, Paris (FR)

(21) Appl. No.: 10/576,345

(22) PCT Filed: Oct. 21, 2003
(86) PCT No.: PCT/FR04/50526

§ 371 Date: Oct. 23, 2006

(30) Foreign Application Priority Data
Oct. 31, 2003 (FR) 03 50764

(51) Int. Cl. G01N 21/00

(52) U.S. Cl. 422/57

(57) ABSTRACT

The present invention relates to an operating device characterized in that it comprises an active surface that is substantially non-wetting with respect to a liquid of interest; at least one zone for the localized capture of a drop of said liquid formed on said active surface; at least one operating zone arranged with a capture zone in such a way that the operating zone is at least partially covered by the drop of the liquid when said drop is captured by said capture zone; and means for leaving a drop of said liquid on said capture zone. This device makes it possible in particular to form high-density arrays of drops of said liquid on a surface, with the aim in particular of carrying out chemical and/or biochemical reactions and/or of analysing the liquid of interest in each drop. It finds, for example, an application in biological chips.

This patent application claims the priority of the French patent application filed on Oct. 31, 2003 under number 03 50764 which is incorporated herein by reference.

### TECHNICAL FIELD

The present invention relates to an operating device, to a small plate, to a system and to a chip comprising localized zones for the capture of a drop of a liquid of interest.

The present invention makes it possible to obtain a high-density array of localized drops on a surface, using a liquid of interest. It makes it possible, for example, to readily ensure the transition from a closed fluidic chamber filled with a liquid of interest to an array of drops, or microvolumes, perfectly located on a surface placed in said fluidic chamber, when the liquid of interest is evacuated from said fluidic chamber.

The term “array of drops” is intended to mean a given arrangement of said drops, without any specific geometrical shape of said arrangement being required. The array of drops can be round, square, polygonal and even random, the essential feature being that the drops formed are arranged in a localized given manner on the surface in accordance with the objective achieved by the present invention. The term “localized” is intended to mean contained, individualized and distinct from the other drops intentionally captured on said surface by means of the device of the invention.

Each of the drops can be subjected to one or more operations intended to qualitatively and/or quantitatively analyse one or more analyte(s) present or liable to be present in the liquid of interest, for example a molecule, an oligonucleotide, a protein, etc.

The analysis of the analytes in the drop can be carried out by any technique known to those skilled in the art for performing analyses, in particular in a volume of liquid as small as a drop. They may be analytical techniques used on biological chips. The analysis may or may not involve the surface of the device of the invention covered by the drop, depending on the use of the present invention.

Each of the drops forms a volume in which chemical or biochemical reactions can be carried out. Any chemical or biochemical reaction known to those skilled in the art can be carried out in this volume. These reactions may or may not involve the surface of the device of the invention covered by the drop, depending on the use of the present invention. When these reactions involve the surface of the device of the invention covered by the drop, they may do so with a single drop or several drops deposited successively on this surface, these successive drops consisting of a single or several different liquids of interest according to the use of the present invention. An example of chemical reactions involving two different liquids of interest on a device of the invention is as follows: by means of a drop of a first liquid of interest, localized deposition of a film of an organic polymer on the surface covered by this drop, and then, by means of a drop of a second liquid of interest, functionalization of the organic polymer film deposited on this surface.

According to the present invention, an analysis or analyses and chemical/biochemical reaction(s) can be carried out exclusively on a device in accordance with the present invention (analysis or reaction), or in a complementary manner. In the latter case, this may be simultaneously (reaction and analysis) or successively (reaction then analysis or analysis then reaction). Furthermore, several analyses and/or several reactions can follow on from one another. For example, the device of the present invention can advantageously be involved, firstly, in the fabrication of a card, or lab-on-chip (for example, by means of chemical reactions making it possible to deposit a polymer, and then to functionalize it), in which all the steps required for the qualitative and quantitative analyses of a liquid of interest are integrated: handling of fluid, chemical and/or biochemical reactions, optical, electrical and/or chemical detection chip, etc.; and, secondly, in the use of this card, or lab-on-chip, for carrying out qualitative and/or quantitative analyses in drops of a liquid of interest to be analysed (chemical/biochemical reaction(s) and analysis).

Given this very large number of applications, the device of the present invention is hereby called “operating device”.

In the present description, the references between [ ] refer to the attached reference list.

### PRIOR ART

No prior publication has been reported regarding the principle of the present invention.

However, depending on the applications envisaged, this invention comes close to several specific fields: formation of drops, operating in microvolume(s), high-density arrays of drops or spots.

The formation of localized zones for isolating a liquid phase is widespread in the field of biological chips, and in particular of DNA chips. For these applications, the reaction volume is often very small in order to save on the biological products and the reagents.

For the formation of localized drops and of high-density arrays of drops, the companies Protogene Laboratories Inc. [1] and Affymetrix Inc. [2] have separately developed methods for creating hydrophilic zones in the middle of a hydrophobic surface. The aqueous phase of interest is subsequently deposited in the form of microdrops by means of an automated dispensing system. These methods result in the reproducible formation of drops and of high-density arrays of spots or of drops.

However, they all require the use of a drop dispensing system that includes a device for precise movement and alignment, and also a liquid feed device. The cost of this equipment is high. Furthermore, the maximum density of the arrays is limited by a combination of the size of the drops dispensed and the minimum inter-spot step of the dispensing system. Finally, the hydrophilic zones described in these documents are always disks whose surface also represents the operating zone. Furthermore, these systems cannot be used in the context of a measurement or a functionalization by electrical means since these devices do not have an electrode.

For the formation of high-density arrays of microcups, two significant examples can be cited: the formation of a network of microfabricated cups by etching in a silicon plate in order to carry out DNA amplifications via PCR in microvolumes of a few picolitres, and the formation of wells or of channels by photolithography on photosensitive resins deposited onto a plastic substrate [3]. With these techniques, the number of wells ranges from 100 to 9600 wells, with diameters of 60 to 500 μm and depths of 5 to 300 μm.

However, the edges of these cups do not leave any physical separation between the liquid phase in the cup and that outside, and therefore permit connections between the cups, and therefore contaminations between them.

One of the most important applications of the present invention is the electrical or electrochemical detection of biological molecules present in a liquid of interest with signal amplification by enzymatic accumulation.

As regards the electrical or electrochemical detection of biological tests, a large number of electrical or electrochemical detection systems described in the literature do not make it possible to go below nanomolar in terms of detection limit, a limitation which is often due to the small number of electrons generated by each hybrid.

The systems involving an enzymatic accumulation make it possible to decrease this detection limit to approximately picomolar due to the high amplification of the number of redox species to be detected that are present in the reaction medium [4]. However, this amplification method engenders a problem for the multispot systems currently known since the redox compound diffuses and can thus contaminate the neighbouring spots. In order to avoid this problem, it is therefore necessary to confine each spot.

With this aim, most commonly, the use of three-dimensional structures (use of compartments) is recommended in the literature. For example, Infineon [6] proposes polymer walls and a system of migration of the molecules by electrical forces, so as to confine them in a defined volume and to thus prevent the inter-spot contamination. Unfortunately, fluidic filling problems can be encountered with this type of approach when it is desired, for example, to operate in a very fine liquid stream. Here again, a drop dispenser becomes essential.

There is therefore a real need for a device for readily obtaining a high-density array of drops from a liquid of interest, that can be used without any drop dispensing equipment, that is easy to fabricate, that makes it possible to effectively avoid contaminations between the drops, and that can be used very flexibly with all the methods currently known to those skilled in the art for collectively or individually analysing microvolumes, for example on a lab-on-chip, regardless of whether this involves a chemical, electrical or optical method or a combination of these methods.

### DISCLOSURE OF THE INVENTION

The present invention corresponds specifically to this need, and also to others, explained below, by providing an operating device comprising:
a substrate comprising an active surface that is substantially non-wetting with respect to a liquid of interest,
at least one zone for the localized capture of a drop of said liquid of interest formed on said active surface,
at least one operating zone arranged with the capture zone in such a way that the operating zone is at least partially covered by the drop of the liquid of interest when said drop is captured by said capture zone,
means for supplying the liquid of interest that make it possible to leave a drop of said liquid of interest on said capture zone.

The present invention also satisfies this need by providing an operating plate comprising several operating devices in accordance with the present invention, which may be identical or different in terms of the embodiment thereof.

The present invention also satisfies this need by providing a biological chip comprising an operating device according to the invention or a plate according to the invention.

The present invention also satisfies this need by providing a system comprising one or more operating device(s) according to the invention.

The present invention also satisfies this need by providing an operating box comprising:
a container comprising means for the introduction of a liquid of interest into this container and for the withdrawal of the liquid of interest from this container,
an operating device according to the invention or a plate according to the invention, placed in said container,

the means for the introduction and for the withdrawal of the liquid of interest into and from the container being arranged in such a way that, when the liquid of interest is introduced into the container, it covers the at least one capture zone(s), and then, when the liquid of interest is withdrawn from the container, a drop of said liquid of interest remains captive by virtue of said capture zone.

The present invention also satisfies this need by providing a system comprising an operating box according to the invention.

In the context of the present invention, a liquid is said to be “of interest” once this liquid is intended to be captured by one or more capture zone(s) of a device according to the invention, for example so as to form an array of drops of this liquid.

The term “liquid of interest” is intended to mean any liquid that may need to be arranged in an array of drops on a support, for example with an analytical and/or chemical and/or biochemical aim. The expression “chemical and/or biochemical aim” is intended to mean any chemical and/or biochemical reaction which can be carried out in the liquid. The term “analytical aim” is intended to mean any qualitative and/or quantitative analysis which can be carried out in a liquid.

The liquid of interest can be organic or aqueous. It may be any one of the liquids currently handled in the laboratory or in industry, for example on lab-on-chips. It may, for example, be a liquid chosen from a solution, a solvent, a reagent, a sample, a cell extract, a sample taken from an animal or plant organism, a sample taken from nature or from industry, etc. It may be a biological or chemical liquid. This liquid of interest may be a liquid that is diluted, if necessary, in order to be used with the device of the present invention, as can be done on lab-on-chips. A solid product can be dissolved so as to constitute a liquid of interest for the purpose of the present invention. This solid product may be chosen, for example, from a chemical or biochemical product, a reagent, a material to be analysed, a sample taken from an animal or a plant organism, a sample taken from nature or from industry, etc. Those skilled in the art are aware of how to handle such products and liquids of interests.

The substrate of the operating device of the invention in fact constitutes the support on which the active surface, the at least one capture zone, and the at least one operating zone are formed. It may consist of any material that is suitable for implementing the present invention. It may, for example, be one of the base materials used for fabricating lab-on-chips, biological chips, microsystems, etc. It may, for example, be a material chosen from the group consisting of silicon; silicon oxide; glass; silicon nitride; of polymers, for example organic polymers such as those chosen from the group comprising polycarbonates, polydimethylsiloxanes, poly(methyl methacrylate)s, polychlorobiphenyls and cycloolefin copolymers; and a metal or a metal alloy, for example chosen from Al, Au or stainless steel.

The term “active surface” is intended to mean surface of the substrate on which the at least one capture zone and the at least one operating zone arranged with said capture zone are formed. According to the invention, the substrate may comprise one or more active surfaces. According to the invention, each active surface may comprise several capture zones arranged, respectively, with one or more operating zone(s).

The active surface may consist of any material that is substantially non-wetting with respect to the liquid of interest and suitable for implementing the present invention. In fact, the operating of the device of the present invention is based partly on the fact that the active surface does not retain the liquid of interest, or retains it very sparingly, which allows complete, ready dewetting, without retention of any liquid of interest on the surface, and without drying.

The active surface preferably forms a contact angle with the liquid of interest of at least 60°. Thus, the drops of liquid of interest are captured selectively and exclusively by the capture zone(s), and are contained in these zones, which avoids any problem of contamination between the drops, and therefore between the operating zones.

The material of the active surface is therefore chosen according to the liquid of interest from which an array of drops must be formed, but also according to the substrate, and according to the operating and capture zones. It may be placed on the substrate by chemical modification or by deposition. It may also be the substrate itself if it consists of a material that is substantially non-wetting in nature with respect to the liquid of interest. In the latter case, no further chemical modification is required.

For example, when the liquid of interest is aqueous, the material forming the active surface is advantageously hydrophobic. For example, in the abovementioned examples of materials constituting the substrate, the surface of the substrate can be rendered non-wetting, here hydrophobic, by chemical modification, for example by silanization with a silane bearing hydrophobic functions, for example 1H, 1H, 2H, 2H-perfluorodecyltrichlorosilane. It may, for example, also involve a deposition of liquid Teflon on a rotating plate; a gas-phase silanization of hydrophobic silane; the use of hydrocarbon-based silane, for example of the octadecyltrichlorosilane type. The materials and methods that can be used for carrying out such chemical modifications are known to those skilled in the art. An example of implementation is given below.

The treatment for rendering the surface of the substrate of non-wetting with respect to the liquid of interest can be carried out before or after the formation of the capture zone(s) and/or of the corresponding operating zone(s). The latter will be protected when said treatment is carried out after the latter.

The shape and the size of this active surface, and therefore also of the substrate on which it is formed, are not important for the operating of the device of the invention. They can be determined, for example, according to the number of capture zones coupled to operating zones formed thereon, and optionally to their arrangement on this surface, and also according to the desired size of the device as it will be used and to the cost specifications. However, in order to avoid unanticipated retentions of the liquid of interest on the surface, it is preferably chosen to be planar. For example, the active surface can have a shape and a size comparable to the plates used for the fabrication of lab-on-chips and of the analysis and detection microsystems known to those skilled in the art.

According to the invention, the active surface, or the substrate on which the surface is formed, is modified by structuring or surface treatment in order to create the capture and operating zones of the device of the invention.

The capture zones are very localized zones that are wetting with respect to the liquid of interest, i.e. that have a high affinity for this liquid of interest. The term “localized” is defined above. For example, in a basic use of the device, by causing a small amount of liquid of interest to flow over the active surface, the capture zone captures, or retains, a drop of liquid of interest, whereas the active zone, that is substantially non-wetting with respect to the liquid of interest, retains very little liquid of interest, or none at all. By stopping the flow, only the drop of liquid of interest retained locally by the capture zone remains on the active surface.

According to the invention, the at least one capture zone can be a zone of chemical, electrical or physical capture of a drop of liquid of interest.

For example, according to a first embodiment of the device of the invention, the capture zone consists of a support material which is placed in a given manner on said active surface or on the substrate and which, if necessary, can be chemically modified so as to render it wetting with respect to the liquid of interest, for example by grafting thereon a chemical function that is wetting with respect to said liquid of interest.

For example, this support material can consist of a material chosen from the group consisting of silicon, silicon oxide (SiO₂); glass; silicon nitride (Si₃N₄); polymers, for example organic polymers such as those chosen from the group comprising polycarbonates, polydimethylsiloxanes, poly(methyl methacrylate)s, polychlorobiphenyls and cycloolefin copolymers; and a metal or a metal alloy, for example chosen from Al, Au or stainless steel.

For example, the chemical function that is wetting with respect to an aqueous liquid of interest can be chosen from the group consisting of an alcohol, alkoxide, carboxylic acid, carboxylate, sulphonic acid, sulphonate, oxiamine, hydrazine, amine and ammonium function.

By way of example, the following two methods (1) and (2) can be used to fabricate this type of capture zone:

(1) on a substrate chosen from the above-mentioned materials (for example, insulating), the following steps can be carried out:

i) Deposition by evaporation or spraying of one or more layers of metals (support) chosen from Ti, Pt, Au, Pd, Ni, Al, etc., with Au as obligatory final layer. However, if the operating zone is an electrochemical microcell (see below), the electrodes of this microcell will preferably not be made of gold.

ii) Definition of units in the metal layer by photolithography and then etching of the metals, for example in a chemical etching bath, or in the gas phase with a plasma, so as to form a capture zone.

iii) Deposition of an insulating material (SiO₂ or Si₃N₄) on the entire substrate and then definition of units by photolithography and localized etching in a chemical etching bath or in the gas phase with a plasma so as to remove the insulating material from the zones that must be in contact with the liquid of interest.

iv) Production of the active surface that is non-wetting with respect to the liquid of interest, on the entire substrate, for example so as to render it hydrophobic, by silanization of the SiO₂ or of the Si₃N₄ with a silane bearing hydrophobic functions, for example with 1H,1H,2H,2H-perfluorodecyltrichloro-silane; and then the capture zone obtained is cleaned, for example chemically, for example with a solution of NaOH; electrochemically, for example by application of a potential of 1.2 V for 10 s; or by oxygen plasma. The operating zone, if it is already formed on the surface, is subsequently cleaned, if necessary, by the same means as those used for the capture zone.

v) Production of the hydrophilic barrier on the capture zone, here made of gold, by physisorption of thiols, for example in the manner described in document [10], bearing functions that are wetting with respect to the liquid of interest for which this device is intended.

(2) When the substrate is chosen from SiO₂ or Si₃N₄, it is also possible, for example, to carry out the following steps:

x) Production of the active surface that is non-wetting with respect to the liquid of interest, on the entire substrate, for example so as to render it hydrophobic, by silanization of the SiO₂ or of the Si₃N₄ with a silane bearing hydrophobic functions, for example with 1H,1H,2H,2H-perfluorodecyl-trichlorosilane,

y) Definition of units by photolithography and then destruction of the hydrophobic silane chemically, for example by means of a solution of NaOH, or by means of a plasma so as to form the zone where the capture zone (or wetting band) will be formed,

z) Production of the capture zone, for example by silanization with a silane bearing functions that are wetting with respect to the liquid of interest for which this device is intended, for example with silanes bearing functions that are wetting with respect to the aqueous solutions described above, for example the silane γ-aminopropyltriethoxysilane. Document [9] discloses methods that can be used.

For example, according to a second embodiment of the device of the invention, in particular when the device of the invention is intended to be used with aqueous liquids of interest and when the active surface or the substrate is silicon-based, the capture zone can consist of hydrophilic black silicon, which can be very readily formed on such a surface by etching. The etched zone then becomes particularly wetting with respect to an aqueous liquid of interest. The etched zone does not require any other chemical modification in order to be wetting. This embodiment is therefore very economical. Document [11] discloses an example of a laboratory protocol that can be used to fabricate capture zones of this type.

For example, according to a third embodiment of the device of the present invention, the capture zone can be an electrode for capture by wetting. According to this embodiment of the present invention, the capture zone, in this case an electrode, can consist, for example, of a material chosen from the group consisting of the noble metals, for example Au, Pt, Pd, Ti, Ni, Al, etc., or an alloy of noble metals; of carbon; of graphite; and of indium tin oxide (ITO); said material being rendered wetting by electrodeposition thereon of an electrically conducting polymer to which is attached a chemical function that is wetting with respect to the liquid of interest.

According to the invention, the electrically conducting polymer can be one of the polymers used in the fabrication of lab-on-chips. It can be chosen, for example, from the group consisting of polypyrrole, polyaniline, polyazulene, a polythiophene, polyindole, polyfuran, and polyfluorene. The wetting chemical function can, for example, be one of the wetting chemical functions mentioned above. The attachment thereof to the monomer before polymerization or to the polymer once it is formed can be carried out by conventional chemical techniques.

An example of a method for the fabrication of this type of capture zone can be summarized in the following way:

(3) On a substrate (insulating substrate) chosen from material such as SiO₂, Si₃N₄, glass or polymer, the following steps can be carried out:

α) Deposition by evaporation or spraying of one or more layers of metals (support) chosen from the abovementioned metals, with, as final layer, a metal chosen from Pt and Au or any other noble metal or an alloy of these metals. This can also be a deposition of carbon, graphite, ITO, etc.

β) Definition of units in the metal layer by etching of the metals, for example in a chemical etching bath, or in the gas phase with a plasma, so as to form one or more electrode(s) and one or more current inlet metal band(s).

γ) Protection of the current inlet metal band(s) by deposition of an insulating material (SiO₂ or Si₃N₄) and then definition of units by photolithography and then localized etching in a chemical etching bath or in the gaseous phase with a plasma so as to remove the insulating material from the zones that must be functionalized or in contact with the liquid of interest.

δ) Production of the active surface that is non-wetting with respect to the liquid of interest, on the entire substrate, for example so as to render it hydrophobic, by silanization of the SiO₂ or of the Si₃N₄ with a silane bearing hydrophobic functions, for example with 1H,1H,2H,2H-perfluorodecyl-trichlorosilane. The electrodes are subsequently cleaned, for example chemically, for example with a solution of NaOH; electrochemically, for example by application of a potential of 1.2 V for 10 s; or by plasma. The operating zone, if it is already formed on the surface, is subsequently cleaned, if necessary, for example with the same means used for the electrode.)

∈) Production of the hydrophilic barrier on the electrode that is outermost when there are several electrodes per device according to the invention (when the operating zone is an electrochemical microcell) by potentiostatic, galvanostatic, or repeated scanning electropolymerization of an electrically conducting polymer bearing functions that are wetting with respect to the liquid of interest for which the device is intended. Examples of wetting polymers and functions are given above.

For example, according to a fourth embodiment of the device of the present invention, the capture zone may be an electrode for capture by electroactivation of chemical functions. This embodiment is substantially identical to the third embodiment mentioned above apart from the fact that the wetting chemical functions used are chosen in such a way that they can be electroactivated or electrodeactivated. Thus, for example in the case of electroactivatable chemical functions, it is necessary to apply an electric current to the electrode constituting the capture zone so that the wetting chemical functions of this electrode are activated and capture a drop of the liquid of interest. By interrupting the application of the electric current, the wetting functions are deactivated, and the drop of liquid of interest is released. This embodiment advantageously makes it possible to place on the operating zones, after the first drop of liquid of interest, a drop of a second liquid of interest (and so on), for example for rinsing or containing chemical reagents for carrying out a chemical analysis or a chemical modification of analytes or of elements originally present in the first liquid of interest and then bound to probes attached to the operating zone. The operating zone can then constitute a true microreactor on which successive steps of a protocol using various solutions can be carried out.

According to a fifth embodiment, the capture zone can be a zone for capture by electrowetting. In this embodiment, the electrowetting making it possible to capture a drop of liquid of interest consists in applying a potential between two electrodes, one of which is coated with an insulating material that is non-wetting. A drop of liquid placed between these two electrodes will come to wet the non-wetting surface. In the current systems, with two opposite electrodes, it is possible to retain a liquid locally by virtue of this system. The document referenced [7] discloses protocols that can be used to implement this fifth embodiment of the present invention.

For example, according to a sixth embodiment of the device of the present invention, the capture zone may be an etching of, or a projection on, the active surface making it possible to capture the drop by capillary forces. These etchings or projections can be produced, for example, by direct etching of the substrate; by deposition of a material at the surface of a planar substrate, for example by coating, evaporation, spraying, or electrochemical deposition, and then etching in conjunction with a conventional photolithography process, for example by resin coating, insulation and definition of units, or etching; by direct definition of units by photolithography in photosensitive polymers, for example in the case of photosensitive resins; moulding or stamping plastics. The essential point is that these etchings or projections forming zones make it possible to capture, in a manner localized to this zone, by capillarity, a drop of the liquid of interest and that this drop at least partially covers the operating zone.

Whatever the embodiment chosen, when the liquid of interest is aqueous, the capture zone is most preferably a hydrophilic zone and the substantially non-wetting active surface is most preferably hydrophobic.

Whatever the embodiment chosen, advantageously, the capture zone and the corresponding operating zone(s) can be placed in a hollow (or cup) or on a projection (or spot) relative to the active surface. Thus, the capture zone and the corresponding operating zone are a relief relative to the active surface, either on spots, or in cups. This can make it possible to obtain better containment of the drop captured by each capture zone, and also to further improve the properties of the device of the invention as regards non-contamination between the operating zones. This type of hollow or projection exists, for example, in the current lab-on-chips. However, in the present invention, these hollows and projections will be sufficiently far from one another, particularly when projections are evolved, and of sufficient diameter, particularly when hollows are involved, so that the liquid of interest is not captured by them due to capillarity between the projections or in the hollows, but by the capture zones located on these projections or in these hollows. They can be obtained by stamping, moulding, etching, or any other technique known to those skilled in the art and suitable for the material constituting the substrate on which the active surface of the present invention is formed.

According to the invention, the capture zone can have any shape. This zone can be chosen, by way of example, from an annular shape, a star shape, a rectangular shape, a square shape, a triangular shape, an elliptical shape, or a 4- to 20-sided polygonal shape, or any other form suitable for the implementation of the present invention. Preferably, the shape is annular, open or closed. In general, it is in the shape of a band. Generally, this band has a width and a thickness which depend on the size of the device overall (capture zone+operating zone). In fact, this width and this thickness must allow the capture of a drop of liquid of interest. Examples of sizes are given below. Be that as it may, according to the invention, the capture zone is arranged with the operating zone in such a way that, if a drop of liquid of interest is captured by said capture zone, this drop at least partially covers the operating zone. Preferably, according to the invention, the capture zone surrounds the operating zone, continuously or discontinuously.

Moreover, according to a specific embodiment of the device of the present invention, a capture zone for a drop of liquid of interest can surround several operating zones, for example from 2 to 4 or more, provided that, when a drop of liquid of interest is captured by the capture zone, this drop at least partially covers all the operating zones which are surrounded by this capture zone.

The term “operating zone” is intended to mean a zone in which physical and/or chemical and/or optical operations can be carried out in the drop captured by the capture zone with which it is arranged. Thus, according to the invention, the at least one operating zone can be a zone of interaction chosen from a zone of electrical, chemical, mechanical or optical interaction with said drop of liquid of interest captured, or a zone in which several of these interactions are simultaneously or successively used.

Thus, according to a first embodiment of the invention, the operating zone can be a zone of electrical interaction, for example an electrochemical microcell.

An electrochemical microcell is a device having at least two electrodes, which are preferably coplanar, forming a working electrode and a counter electrode. It can also have a reference electrode. These elements are known to those skilled in the art. The methods of fabrication known to those skilled in the art can be used to fabricate this operating zone, for example the method described in the document referenced [8].

By virtue of this embodiment, the device of the present invention can constitute a true electrochemical microreactor which uses the drop of liquid of interest captured by the capture zone as a reaction medium, and more specifically as an electrochemical medium. The electrochemical reactor according to this first embodiment of the present invention can be used to carry out any electrochemical reaction and/or analysis known to those skilled in the art.

This reactor can be used, for example, to carry out reactions consisting of localized electropolymerization of one or more monomer(s) present in the drop (polymerization or copolymerization) and/or of localized electrografting of one or more chemical molecule(s) present in the drop of the liquid of interest on one of the electrodes of the microcell. In this example, the liquid of interest is then a liquid containing the reagents required for the desired electropolymerization or electrografting. The polymerization and the grafting can be advantageously localized in the drop of the liquid of interest captured by the capture zone. Such localized electropolymerization or grafting reactions can be used, for example, for the fabrication of biological chips or analytical systems.

This electrochemical microreactor can also be used, for example, to carry out qualitative and/or quantitative electrochemical analyses of analytes present in the drop of a liquid of interest captured by the capture zone. It can also be used, for example, to carry out qualitative and/or quantitative electrochemical analyses of a probe/target molecular recognition, the probe being attached to the operating zone, and the target being in the drop of the liquid of interest captured.

In a specific example, the electrochemical microcell of the device of the invention can be used first to “fabricate” the operating zone, and subsequently to use this operating zone for the analysis of a drop of a liquid of interest. For example, if the operating zone must comprise an organic polymer functionalized with a probe, for example a biological probe, it can be fabricated by electropolymerization of a conductive polymer functionalized with a probe, for example according to the method described in the document referenced [5]. The particularity associated with the use of the device of the invention is that the capture zone is used to capture, in a localized manner on the operating zone, a first drop of a first liquid of interest containing the reagents required for the electropolymerization (organic monomer). The functionalization with the probe can be carried out simultaneously with the electropolymerization, the first liquid of interest then also contains the probe (for example, monomer functionalized with the probe). The functionalization can also be carried out subsequent to the electropolymerization, by means of a second drop of a second liquid of interest (containing the probe) captured by the same capture zone and, as a result, localized on the same operating zone. Furthermore, the operating zone thus fabricated can subsequently be dried, and it can be used, still by virtue of the capture zone with which it is arranged, to capture a drop of a third liquid of interest to be analysed, containing a target which interacts with the probe (for example, complementary oligonucleotides). A fourth liquid of interest can also be used for analysing (detection and/or assay) the probe-target interaction on said operating zone, and so on.

In a specific example, where the electrochemical microcell of a device of the present invention is used for detecting a target present in a liquid sample, for example by involving an interaction of the target to be detected with a specific probe attached to the operating zone, it is possible to electrochemically detect said interaction, for example with signal amplification by enzymatic accumulation in a drop of a liquid of interest, containing an enzymatic substrate, captured by the capture zone arranged with this operating zone. Document [4] discloses an operating protocol that can be used for this type of detection, with the device of the present invention.

The detection of a probe/target interaction on the operating zone can involve one of the means known to those skilled in the art other than the electrochemical cell, for example an optical method. The electrochemical microcell can therefore be used, in this case only, to “fabricate” the operating zone, the detection of a probe/target interaction subsequently being carried out by another means.

In these examples, various drops consisting of various liquids of interest are therefore captured successively by the same capture zone on the device of the present invention for various purposes, for example so as to carry out successive steps of a protocol for the fabrication of the operating zone, for example also so as to carry out successive steps for detecting and/or assaying an analyte in a liquid of interest. The advantage associated with the present invention is that, whatever the objective of the successive captures of drops of liquids of interest, the drops successively captured are all localized on the operating zones, by virtue of their respective capture zone.

Whatever the use of this embodiment characterized by the presence of an electrochemical microcell, the probe which functionalizes the operating zone can be chosen, for example, from the group consisting of an enzyme, an enzyme substrate, an oligonucleotide, an oligonucleoside, a protein, a membrane receptor of a eukaryotic or prokaryotic cell, an antibody, an antigen, a hormone, a metabolite of a living organism, a toxin of a living organism, a polynucleotide, a polynucleoside, and a complementary DNA. It is of course chosen according to the target with which it will have to interact.

Advantageously, according to this first embodiment of the device of the invention, the outermost electrode of the microcell can be used to form the wetting capture zone or band of the device of the invention. In this case, as disclosed above, a conductive polymer bearing the wetting function intended to form the capture zone is deposited on this electrode. For this deposition, the polymer can be electrodeposited onto the electrode by virtue of the electrochemical cell forming the operating zone. Methods that can be used for depositing a conductive polymer onto an electrode and binding thereto a wetting chemical function are described above in the third embodiment of the capture zone according to the invention. The shape of this electrode is of no importance provided that it surrounds the operating zone in accordance with the present invention.

According to the invention, the electrode forming the capture zone for a drop of liquid of interest can operate completely independently of the operating zone. It can also operate in a dependent manner, by being subsequently used in the operation of the electrochemical microcell, for example for carrying out electrochemical measurements and/or electrochemical reactions in the captured drop. The capture zone of the device of the present invention can therefore be active or non-active depending on the choice of use of the device of the invention.

Also advantageously, the capture electrode for a drop of liquid of interest can also be functionalized with a probe intended to interact with a target. For example, when the capture zone is formed according to the third embodiment of the present invention, the conductive polymer functionalized with a chemical function that is wetting with respect to the liquid of interest can also be, in addition, functionalized with said probe intended to interact with a target. The probe is defined above for the operating zone. The methods known to those skilled in the art for functionalizing a conductive polymer with a probe for the fabrication of biological chips can be used for the fabrication of this specific capture zone of the present invention. They may, by way of example, be the methods disclosed in the abovementioned documents.

According to a second embodiment of the invention, the operating zone can be a zone of chemical interaction with the drop of liquid of interest captured, without an electrochemical microcell. The operating zone can, for example, comprise functions or chemical or biological reagents ready to react with a target of these functions or of these reagents that is present in a liquid of interest. As for the first embodiment, the device of the invention can be used, firstly, to place these functions or these reagents on the operating zone and, secondly, after drying, to capture a drop of liquid of interest containing the target of these functions or of these reagents, for the analysis thereof. As for the first embodiment, several liquids of interest may follow on from one another on the device of the invention, for example for carrying out successive steps of a protocol for the fabrication of the operating zone, for example also for carrying out successive steps for detecting and/or assaying an analyte in a liquid of interest. The advantages are the same as those mentioned above.

This operating zone can be chosen from those that are known to those skilled in the art in the field of biological chips (chips sold by Agilent, Ciphergen, Eurogentec). The difference between the device of the present invention and these chips of the prior art lies especially in the presence of the capture zone for a drop of liquid of interest arranged with said operating zone. This operating zone can be fabricated, for example, by silanization and then immobilization of biological probes, as is described, for example, in the document referenced [12].

This operating zone can, for example, be a zone comprising a polymer functionalized with a biological probe such as those mentioned above, with the aim of binding a corresponding target that may be present in a liquid of interest, so as to detect it, for example optically. For example, on a substrate such as those mentioned above, this operating zone can be obtained according to the methods described in the document referenced [13]. The chips thus functionalized can subsequently, by virtue of the capture zone of the device of the invention, be used to capture a drop of a sample to be analysed and then, optionally, of another liquid of interest so as to demonstrate a probe/target interaction.

According to a third embodiment of the invention, the operating zone can have active or measuring devices, such as sensors or actuators. This embodiment can be added to the above-mentioned embodiments and variants, or can be exclusive depending on the intended objective of the use of the present invention. The active or measuring devices are advantageously located at the centre of the capture zones.

When the operating zone comprises a sensor, it can be chosen, for example, from the group consisting of electrical, magnetic, electrostatic, mechanical (for example pressure sensor), thermal (for example temperature sensors), optical (for example optical detection device) and chemical sensors.

When the operating zone comprises an actuator, it can be chosen, for example, from the group consisting of optical (light source), electrical, magnetic, electrostatic, mechanical (mechanical displacement), thermal (heating resistance) and chemical actuators.

Such sensors and actuators that can be used for implementing the present invention and also the method for the fabrication thereof are known to those skilled in the art, in particular in the field of microsystems. Here again, the difference between the device of the present invention and these chips of the prior art lies in particular in the presence of the capture zone for the liquid of interest arranged with said operating zone.

Whatever the embodiment, according to the invention, the at least one operating zone can be a zone that is substantially non-wetting or wetting with respect to the liquid of interest. The inventors have in fact noted, in the course of their experiments, that the wettability of the operating zone is not determining for the operation of the device of the present invention. They have in fact noted that, entirely unexpectedly, the device of the present invention can also operate when the operating zone is non-wetting with respect to the liquid of interest, provided that the drop captured at least partially covers said operating zone.

The present invention also relates to a method for the fabrication of the device of the present invention, comprising the following steps:
providing a substrate comprising a surface chosen to become the active surface,
structuring the chosen surface of the substrate in order to form thereon an operating zone,
applying a treatment to the chosen surface in order to render it substantially non-wetting with respect to the liquid of interest for which the device is intended, and
structuring the chosen surface in order to form a capture zone for a drop of liquid of interest,

the steps consisting in structuring the surface so as to form an operating zone and in structuring the surface so as to form the capture zone being carried out such that the operating zone is arranged with the capture zone in such a way that, when the capture zone captures a drop of liquid of interest, the operating zone is at least partially covered by said drop.

The substrate, the structuring so as to form the operating zone, the treatment of the surface of the substrate intended to render it substantially non-wetting, and the structuring of the surface intended to form the capture zone for a drop of liquid of interest are defined above.

Thus, for example, the step consisting in structuring the surface so as to form the capture zone can consist in forming an electrode intended to form the capture zone, and in electrodepositing onto this electrode a conductive polymer bearing one or more wetting chemical function(s).

Thus, for example, the step consisting in structuring the surface so as to form the operating zone can consist: in fabricating on this surface a sensor; an actuator; a electrochemical microcell; a layer of polymer which is functionalized, or which can be functionalized, with a probe intended to recognise a target that may be present in the liquid of interest.

These steps and the materials that can be used are described above.

The present invention also relates to a working plate comprising several identical or different working devices according to the invention. In fact, the device of the present invention, as presented above, can be arranged in series on a plate, for example so as to form an array, it being possible for the operating zones to be identical over the entire plate, or different, for example so as to be able carry out multiparametric analyses and chemical and biochemical reactions that are different from one zone to another, simultaneously or successively. The plate can consist of the substrate comprising the active surface(s) defined herein. The term “array” is defined above. The number of devices of an operating plate according to the invention depends in particular on the number of analyses to be carried out on this plate. For example, if the plate comprises 1000 devices according to the invention, it will make it possible to capture 1000 drops of liquid of interest on 1000 operating zones, or more when a capture zone surrounds several operating zones, and therefore to simultaneously carry out at least 1000 analyses of the liquid of interest. It is therefore of use, for example, for carrying out a simultaneous multiparametric analysis of the liquid of interest. It makes it possible in particular to fabricate lab-on-chips, for example biological chips and analytical microsystems.

The present invention therefore also relates to a biological chip comprising a device or a plate according to the invention. This chip can, for example, be a nucleic acid chip, an antibody chip, an antigen chip, a protein chip, a cell chip, or a chip comprising several of these functions, for example a nucleic acid and protein chip, an antibody and nucleic acid chip, etc.

The device of the present invention can be miniaturized on a millimetric or micrometric scale; by way of example, from 5 μm to 5 mm. The present invention also relates to a system comprising one or more identical or different operating device(s) according to the invention, or a plate according to the invention. The system can, for example, be an analytical microsystem, for example a micro total analysis system (μTAS).

The fabrication of the plate and of the system in accordance with the present invention can be carried out in the same manner as that disclosed above for the fabrication of the device of the invention. For the parts of these chips and systems which are distinct from the present invention, the methods known to those skilled in the art can be used. In fact, the difference between the device, plate, lab-on-chip and system of the present invention and their homologues of the prior art lies essentially in the presence of the capture zone for the liquid of interest arranged with each operating zone. No restriction is imposed on the choice of the material(s), this choice being guided essentially by the envisaged application and by the cost specifications: conventional microelectronics material used for microsystems (silicon, glass, silicon oxide, silicon nitride, etc.), composite material of technical polymer type available for printed circuits, etc.

In the field of microsystems, where the characteristic size of the device of the invention is close to 100 μm, the orientation of the device is of no importance since the forces of gravity become negligible compared with the forces of capture of the drop by the capture zones, derived from interactions across short distances. On the other hand, for applications aimed at scales of larger size for the implementation of the present invention, the device of the invention is of course preferably placed horizontally with a structuring of the active surface so as to form the capture and operating zones pointing upwards.

In the use of the present invention, the dimensions of a capture zone can vary greatly depending on the use for which it is intended and on the embodiment (one or more operating zones per capture zone, one or more device(s) of the invention on an active surface). For example, for a microsystem, the capture zone can have a diameter ranging from 5 μm to mm. When the capture zone is in the form of a band, this band can have a width of 1 μm to 500 μm and a thickness relative to the active surface of 0 to 500 μm. The operating zone, the dimension of which depends in particular on the capture zone (the drop captured having to at least partially cover this operating zone), can have, for example, with the abovementioned dimensions of the capture zone, a diameter such that it touches the capture zone which may or may not surround it. For example, the operating zone can have a diameter of 5 μm to 5 mm.

In order for the capture zone(s) to capture a drop of liquid of interest, it is necessary to bring the liquid of interest into contact with said capture zone(s). For this, it is possible, for example, to cause the liquid of interest to flow over the capture zone(s) or to immerse the latter in the liquid of interest. According to the invention, the means for leaving a drop of liquid of interest on said localized capture zone can be a syringe, a pipette, a micropipette, a container containing the liquid of interest and into which the device or the plate of the invention can be immersed, etc. It can also be a dispenser of a drop of liquid of interest per capture zone. In fact, in this case, the device of the invention makes it possible to guarantee that there is no contamination between the operating zones. The dispensers that can be used are those normally used, for example, in the lab-on-chip and microsystems field.

The present invention also relates to an operating box as defined above.

In this operating box, the container can be open or closed. This container can be used especially for immersing the device of the invention or the plate of the invention in the liquid of interest, or can be a container which also makes it possible to confine the device or the plate of the invention and/or to carry out analyses on or in the drops captured on the operating zones. In the latter two cases, the container is preferably closed, and the operating box of the present invention then constitutes a true miniature laboratory. It may be used in systems such as analytical microsystems, or may form a biological chip, for example chosen from the group consisting of nucleic acid chips, antibody chips, antigen chips, protein chips and cell chips.

The dimensions of the container depend in particular on the dimensions of the device of the invention, or of the plate of the invention, which must be enclosed in said container, but also, where appropriate, of other analytical devices or systems which can be put together in said container, for example other lab-on-chips. They can drop below a cm for their largest side.

The container can consist, for example, of a material chosen from the group consisting of an organic polymer, an elastomeric plastic, a glass, metal, silicon, and a photosensitive resin, or of any material known to those skilled in the art and allowing the use of the present invention. For example, it may be one of the abovementioned materials forming the substrate of the operating device of the present invention. The material of the container is generally chosen as a function of the type of liquid of interest to be introduced therein, of the use of the container (simply immersion of the device or of the plate, or immersion and analysis) and as a function of the cost specifications of the manufacture. It may be a material identical to or different from the active surface of the device of the invention.

The container is preferably sufficiently leaktight to avoid, for example, leaks during the immersion, in said container, of the device or of the plate according to the invention in the liquid of interest. In particular, when it is closed, it is preferably sufficiently leaktight to prevent, for example, contaminations from entering the container, for example bacterial contamination, chemical contamination, etc.; and/or to prevent the evaporation of the drop(s) captured by the capture zone(s) after the withdrawal of the liquid of interest from the container. Those skilled in the art will be capable of adapting the leaktightness and of using the appropriate materials according to the use that they make of the present invention.

According to a specific embodiment of the operating box of the present invention, when the substrate and the container consist of the same material, the substrate can constitute one of the walls constituting the container.

The walls constituting the container can also be assembled from, and on, the active surface of the device of the invention, for example by bonding or compression.

The container can comprise a cover for the assembly thereof, but also, in certain applications, for opening it or closing it, in particular in order to be able to withdraw therefrom the device or the plate of the invention after having brought it into contact with the liquid of interest, or after the analyses or reactions in the drops. In fact, a single container can also be used to immerse, at the same time or successively, one or, depending on its design, more device(s) or plate(s) according to the invention. The container can then comprise removable means of attachment, for example clips, of the device(s) and/or plate(s) inside it. If the container comprises a cover, it will preferably be sufficiently leaktight so as not to disturb the immersion of the device or of the plate of the invention, as is explained above.

The cover can consist of a material such as those mentioned for the container. It can be made, for example, by moulding, by stamping, by etching or by mechanical erosion, etc. It can then be permanently attached to the container so as to close it, for example by bonding, compression or plating or by any other means known to those skilled in the art and ensuring the performance and the leaktightness required for the use thereof. It can also be removably attached to the container, while still providing the performance and the leaktightness required for the use thereof, so that the same container thus formed can be used for the successive immersion of devices or plates according to the invention, which may be identical or different, and/or with various liquids of interest.

Preferably, the material of the container and, where appropriate, of its cover, is, inside said container (i.e. opposite the substrate and its active surface) substantially non-wetting with respect to the liquid of interest. In fact, this makes it possible to prevent drops from adhering to the internal surfaces of the container, after the withdrawal of the liquid of interest, and falling onto the active surface and impairing the analyses and reactions on the operating zones in the drops captured by the capture zones. Surface treatments may be necessary in order to obtain this result, as for the active surface of the device of the invention. These treatments can, for example, be those mentioned above for the fabrication of the active surface.

The container comprises means for the introduction and for the withdrawal of the liquid of interest into and from said container, comprising at least two openings. When the container is closed, there is no limitation in terms of the position, the shape and the function of these openings other than these: they must allow the introduction and then the withdrawal of the liquid of interest into and from the container; and they must be arranged in such a way that, when the liquid of interest is introduced into the container, it covers the capture zone(s) and, when the liquid of interest is withdrawn from the container, a drop of liquid of interest remains captive per capture zone. The liquid of interest can enter and then leave the container via two different openings. It can also enter and then leave the container via just one of the two openings, a second opening being used to allow the withdrawal of the liquid of interest, either by allowing the air summoned by the withdrawal to pass through, or by injecting, via this second opening, a gaseous fluid that makes it possible to push the liquid of interest out of the container.

The openings for the introduction and for the withdrawal of the liquid of interest into and from the container can be placed on the cover or on the walls of the container, for example by etching, stamping, moulding, exposure to light for a photosensitive resin, mechanical piercing, etc.

The introduction of the liquid of interest into the container can be carried out by any appropriate means known to those skilled in the art for injecting a liquid into a container, in particular those used in the lab-on-chip and microsystems field. This injection means may, for example, be a syringe, a pipette, a micropipette, an injection pump, etc. The withdrawal of the liquid of interest can be carried out by any appropriate means known to those skilled in the art for withdrawing a liquid from a container. The essential point is that the drop(s) captured by the capture zone are not carried away during the withdrawal of the liquid of interest.

For example, according to the invention, the means for the withdrawal of the liquid of interest can consist of a pump for injection of a gaseous fluid via the inlet opening so as to withdraw the liquid of interest by driving it from the container via the outlet opening. Advantageously, the pump for injection of the gaseous fluid via the inlet opening of the container can then comprise a device for saturating the gaseous fluid injected with vapour of the liquid of interest. This saturation makes it possible to prevent or to limit the evaporation of the drop(s) captured by the capture zone(s).

Also for example, the pump for withdrawal of the liquid of interest from the container can consist of a suction pump placed so as to withdraw the liquid of interest from the container by suctioning it via the outlet opening.

The operation of the method for the capture of a drop of liquid of interest per capture zone of the device and of the plate of the invention using the operating box of the invention can be represented schematically in the following way:
complete or partial filling of the container, or fluidic chamber, with the liquid of interest so as to cover the capture zone(s), then
withdrawal of the liquid out of the chamber.

Only the capture zone(s) each retain(s) a drop of liquid of interest, the active surface being non-wetting.

The use of the device, of the plate or of the operating box of the present invention can therefore involve successively one or more operation(s) which take(s) place collectively, with one or more identical or different liquids of interest, followed by individual operations in each of the drops formed.

Thus, for example in a first operation, referred to as collective, the device of the invention allows a fluidic stream of liquid of interest, for example injected into the operating box, to become an array of drops, or microvolumes, independent of one another. Next, methods of detection and/or chemical or biochemical reactions known to those skilled in the art can be carried out individually (individual operation), in parallel or successively, in each of the drops captured by the capture zones.

In multistep methods using the device of the invention, it is not necessary for all the steps to result in the formation of drops. In fact, there is nothing to prevent certain steps from being carried out by covering all the capture and operating zones with a liquid and then emptying the box of this liquid in such a way that no drops captured by the capture zones remain, for example by injection into the box of a pressurized gas, by energetic agitation, etc.

On the same operating zone of the device of the present invention, it is possible to successively capture various drops of one or more liquids of interest, by virtue of the capture zone which surrounds it. Each liquid of interest can contain one or more reagent(s) required, for example, for carrying out one of the steps of a chemical or biochemical method, for example for fabricating the operating zone and/or carrying out analyses. Consequently, the succession of the various drops on the same operating zone makes it possible to carry out the successive steps of the method implemented. All these steps of the method will therefore advantageously be localized on this operating zone by virtue of the capture zone.

In experiments associated with the use of the present invention, the inventors have noted that the device of the invention solves other technical problems, compared with the techniques of the prior art, in the lab-on-chip, biological chip and microsystems fields. In particular, there exists in the prior art a certain number of methods of localized covalent grafting of biological molecules so as to functionalize biological chip surfaces. This localization is in general carried out chemically, photochemically or else electrically. Chemically, the immobilization of a biological element (probe) is carried out by localized deposition (“spotting”) or in situ synthesis, which is restrictive in terms of time. Photochemically, it is possible to carry out oligonucleotide syntheses using photolabile groups [4]: here again, limitations in terms of synthesis times and of volumes of expensive reagents are often encountered. Furthermore, non-selective free-radical reactions can take place. Electrically, the synthesis of oligonucleotides on a solid support with an electrolabile group encounters the same limitations. Electrochemically [3], by copolymerization of pyrrole and of pyrrole bearing a biological species on a metal electrode. The latter technique has the drawback of requiring large volumes of expensive reagents (pyrrole bearing the biological species).

The device of the present invention makes it possible to solve these numerous problems of the prior art. In fact, it makes it possible to rapidly and precisely functionalize biological chip surfaces, which in the present invention have become the operating zones, by virtue of a rapid and precise localization of the liquid of interest on the operating zone(s), and a precise control of the immobilized probe densities. Furthermore, compared with the methods of the prior art, the volumes of reagents used are clearly smaller due to the precise localization of the reaction in the volume of the drops of reagents captured by the capture zones. Furthermore, the inventors' experiments have shown that the device of the present invention makes it possible to carry out procedures in microvolumes independent of one another, without cross contamination between the detection spots, which considerably increases the precision and the reproducibility of the analyses.

Thus, the present invention allows, inter alia, an electrochemical or optical measurement in a confined medium, in the drop captured by the capture zone, but also a localized functionalization on the operating zone, electrochemically or chemically with expensive reagents (volume of reagents restricted to the real useful zone formed by the operating zone surrounded by its capture zone according to the invention).

This invention is currently of greatest advantage in the case of a closed device, for example in lab-on-chip and microsystems applications. However, it should be noted that this invention can also be applied in the case of a dispensing of liquid by an automaton in order to keep a liquid of interest completely localized.

According to the invention, detections of various molecules that may be present in the liquid of interest can be carried out in parallel, simultaneously or successively, in various drops of liquid of interest captive on said active surface in the box.

According to the invention, the at least one analyte to be detected can be chosen, for example, from biological or chemical molecules. The biological molecules can be chosen, for example, from the group consisting of an enzyme, an enzyme substrate, an oligonucleotide, an oligonucleoside, a protein, a membrane receptor of a eukaryotic or prokaryotic cell, a virus, an antibody, an antigen, a hormone, a metabolite of a living organism, a toxin of a living organism, a nucleotide, a nucleoside and a complementary DNA. The chemical molecule may be any molecule which must be qualitatively and/or quantitatively analysed.

Other characteristics and advantages will become further apparent to those skilled in the art upon reading the examples which follow, given by way of non-limiting illustration in reference to the attached figures.

### BRIEF DESCRIPTION OF THE FIGURES

FIGS. 1 and 2 represent diagrammatically various devices in accordance with the present invention.

FIG. 3 represents diagrammatically various embodiments of the device of the present invention.

FIG. 4 represents diagrammatically a device of the invention in which the operating zone is an electrochemical microsystem.

FIGS. 5a) and 5b) are two photographs of a device according to the invention, in which the operating zone is an electrochemical microcell: FIG. 5a) before capture of a drop of liquid of interest, and FIG. 5b) after capture of a drop of liquid of interest.

FIG. 6 is a graph showing the detection, in an operating zone, of a product of an enzymatic reaction within a drop captured by the capture zone corresponding to this operating zone in a device according to the invention.

FIG. 7 represents transverse sections of a possible embodiment of an operating box according to the invention.

FIG. 8 represents transverse sections of a diagrammatic representation of various possible embodiments of an operating box according to the invention, it in particular represents examples of arrangements of the inlet and outlet openings for the liquid of interest on various operating boxes in accordance with the present invention.

FIG. 9 is a diagrammatic representation of a plate according to the invention comprising several devices according to the invention arranged in an array.

### EXAMPLES

### Example 1

### Fabrication of Non-Wetting Active Surfaces According to the Invention

A substrate of silicon (Si) with an upper layer of silicon oxide (SiO₂) of 300 nm is treated with a hydrophobic silane (1H,1H,2H,2H-perfluorodecyl-trichlorosilane) so as to render the surface hydrophobic.

The protocol is as follows: after treatment in a mixture of sodium hydroxide/water/ethanol at 3.5 M for 2 hours at ambient temperature so as to generate the silanol sites, the substrate is placed, for 10 minutes at ambient temperature, in a mixture of anhydrous toluene/hydrophobic silane at 9 mM in terms of silane concentration. It is subsequently washed with toluene then acetone, and then ethanol and, finally, cleaned by ultrasound for 5 minutes in ethanol. The substrate is subsequently placed in an incubator for 1 hour at 110° C. The contact angle measured with water is 110°.

### Example 2

### Fabrication of a Capture Zone Consisting of a Support Material Placed on the Active Surface

On a substrate of Si with a 300 nm layer of SiO₂, steps which are standard for those skilled in the art in microelectronics are carried out:
deposition of 300 nm of platinum (Pt) by spraying;
photolithography in a photosensitive resin with opening of a circular unit connected to a current inlet band;
in a plasma reactor, complete ionic etching of Pt in the zones without resin;
removal of the resin in a bath of nitric acid;
in a plasma reactor, chemical vapour deposition of 500 nm of SiO₂;
photolithography in a photosensitive resin with opening of the circular unit;
in a plasma reactor, complete ionic etching of 500 nm of SiO₂ in the zones without resin; and
removal of the resin in a bath of nitric acid.

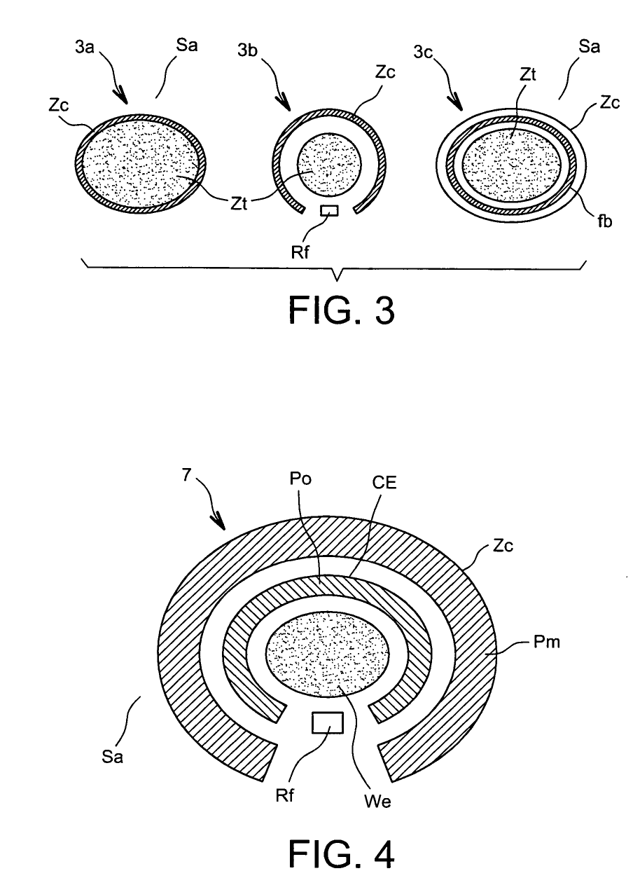

FIG. 3a is a diagrammatic representation of a circular capture zone consisting of a support material and surrounding an operating zone.

### Example 3

### Fabrication of a Capture Zone Consisting of Black Silicon

On a substrate of Si (all these steps are very well known to those skilled in the art in microelectronics):
photolithography in a photosensitive resin with opening of a unit in the form of a ring;
in a plasma reactor, ionic reactive etching of approximately 3 μm of silicon according to the protocol described in document [11] so as to form black silicon;
cleaning of the surface at the end of etching by passage in a Plassys MDS 150 plasma reactor (company Plassis, France) with the following conditions: power 500 W, reaction time 4 minutes, pressure 21.33 Pa (160 mTorr), oxygen flow rate 25 cm³/min., ambient temperature; and
removal of the resin in a bath of nitric acid.

The black silicon formed on these given zones is highly hydrophilic, while the silicon is substantially non-wetting with respect to aqueous liquids of interest (samples).

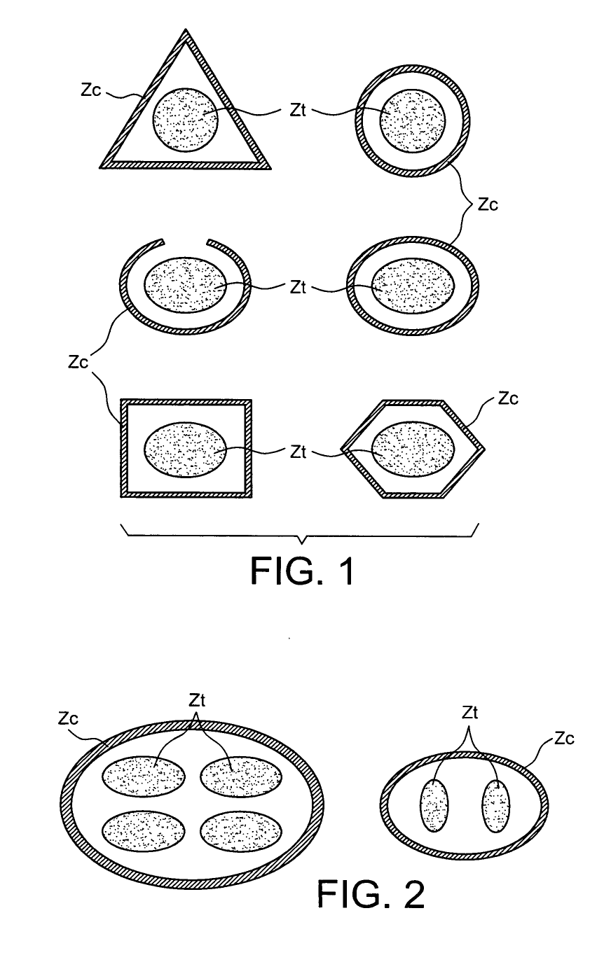

FIGS. 1 and 2 show diagrammatically various capture zones formed around their operating zone(s).

The fine structuring was realized so as to create an open or closed band of black silicon, which constitutes the capture zone (Zc), around a zone intended to form the operating zone (Zt). On FIG. 2, a capture zone is arranged around two (on the right) or four (on the left) operating zones.

The etched zone does not require any other chemical modification. This device of the invention is intended to be used with aqueous liquids of interest.

### Example 4

### Fabrication of a Capture Zone in the Form of an Electrode for Capture by Wetting

4.1 Capture Zone in the Form of a Capture Electrode:

On a substrate of Si with a 300 nm layer of SiO₂, the following steps are carried out:
α) the same steps as in Example 2 are carried out so as to place an electrode (support material) on the active surface.
β) the active surface that is non-wetting with respect to the liquid of interest is produced over the entire surface of the substrate so as to render it hydrophobic, as in Example 1. The electrode is subsequently cleaned chemically with a solution of sodium hydroxide/water/ethanol. To do this, a drop of mixture of sodium hydroxide/water/ethanol at 3.5 M is deposited onto the electrodes for 2 hours at ambient temperature. The electrodes are subsequently washed with water and then dried.
γ) in additional experiments, a hydrophilic barrier was produced on the electrode by potentiostatic electropolymerization of a pyrrole bearing alcohol functions (functions that are wetting with respect to an aqueous liquid of interest) in the 3-position. This polypyrrole is generated from a solution of 100 mM pyrrole-3-ethanol and of 0.5 M lithium perchlorate (LiClO₄). A potential of 1 V versus Ag/AgCl/Cl⁻ is applied for 5 seconds. The measured contact angle with water on the electrode is 53°.

FIG. 3a is a diagrammatic representation of a device according to the invention obtained using the protocol of this example. In this figure, the capture zone (Zc) surrounding the operating zone (Zt) is formed by an electrode coated with a polypyrrole bearing wetting functions (alcohol functions).

4.2 Capture Zone in the Form of a Wetting Band:

On a substrate of Si with a 300 nm layer of SiO₂, the following steps were carried out:
α) the active surface that is non-wetting with respect to the liquid of interest is produced over the entire substrate so as to render it hydrophobic as in Example 1.
β) photolithography in a negative-type photosensitive resin (reference NFR-015 of the supplier Shipley) with an opening of a unit in the form of a ring, so as to form the capture zone (or wetting band);
γ) destruction of the hydrophobic silane in the open units of the photosensitive resin by passage in a Plassys MDS 150 plasma reactor (company Plassys, France) with the following conditions: power 500 W, reaction time 4 minutes, pressure 21.33 Pa (160 mTorr), oxygen flow rate 25 cm³/min., ambient temperature; and
δ) production of the capture zone by silanization with a silane bearing amine functions (functions that are wetting with respect to the aqueous liquid of interest). The substrate is placed in a solution of γ-aminopropyltriethoxy-silane at 10% by volume in ethanol. After being left overnight at ambient temperature, the substrate is washed with ethanol and, finally, left in an incubator at 110° C. for three hours.

### Example 5

### Fabrication of an Operating Zone Functionalized with a Probe According to the Invention

In this example, a chip comprising four electrodes is fabricated and used. On a substrate of Si with a 300 nm layer of SiO₂, steps that are standard for those skilled in the art in microelectronics are carried out:
deposition of 300 nm of platinum (Pt) by spraying;
photolithography in a photosensitive resin with opening of the units of the microcell, of the capture electrode and of the current inlet bands;
in a plasma reactor, complete ionic etching of Pt in the zones without resin;
removal of the resin in a bath of nitric acid;
in a plasma reactor, chemical vapour deposition of 500 nm of SiO₂;
photolithography in a photosensitive resin with opening of the units of the electrodes of the microcell and of the capture electrode;
in a plasma reactor, complete ionic etching of 500 nm of SiO₂ in the zones without resin; and
removal of the resin in a bath of nitric acid.

The working electrode (We), the counter electrode (CE) and the auxiliary electrode used to form the capture zone (Zc) are made of platinum (deposition of approximately 5000 Å) (see FIG. 4).

An Ag/AgCl/Cl⁻ reference electrode (Rf) is also present. This electrode is obtained by deposition of silver onto the platinum with the following protocol:
preparation of 10 ml of solution containing 0.2 M AgNO₃, 2 M Kcl, 0.5 mM Na₂S₂O₃;
a potential of −0.65 V versus SCE (saturated calomel electrode) is imposed for 90 seconds (followed by chronoamperometry) on the reference electrode. A grey/white deposit is obtained. The operating zone is subsequently rinsed with water; and
the operating zone with the previously modified electrode is immersed in a solution of 0.1 M HCl and a potential of 0.5 V versus SCE is imposed for 30 seconds so as to chlorinate the silver deposit. The substrate is subsequently rinsed with water.

All the operating zones were silanized with a hydrophobic silane according to the protocol described in Example 1.

The hydrophilic barrier is produced on the capture electrode according to the protocol described in Example 4.1-(γ).

The counter electrode (CE) is subsequently functionalized with a conductive copolymer of pyrrole/pyrrole functionalized in 1-position with the biological function (in this case, a probe oligonucleotide) [5]. The electropolymerization is localized on the counter electrode of the operating zone.

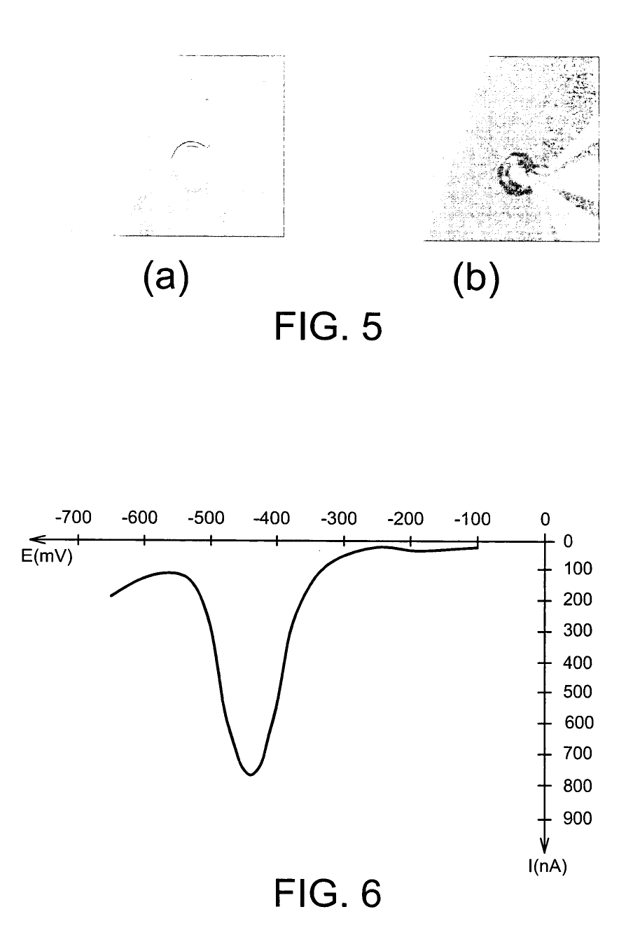

To test this operating zone, the probe oligonucleotide is hybridized with a target oligonucleotide (100 pM) bearing an enzymatic label (HRP, Horse Radish Peroxidase) in a buffer (1 M NaCl/10 mM Tris/1 mM EDTA/0.05% Triton X100). After washes in the same buffer but without triton, the visualizing solution (OPD+H₂O₂+50 mM citrate-phosphate buffer) is introduced onto the device of the present invention and then suctioned off. A fraction of liquid is clearly left in a localized manner on the operating zone, as shown in the photographs of FIG. 5:
on the left, before the device is covered with visualizing solution, the device of the present invention without the drop is distinguished; and
on the right, after the visualizing solution has been suctioned off, the device of the present invention having captured, by virtue of its capture zone (hydrophilic band), a drop of the visualizing solution is distinguished.

After visualization for 5 minutes, the enzymatic product is detected by differential pulsed voltamperometry on the measuring electrode (WE). The results of this detection are represented by the graph in the attached FIG. 6.

FIG. 4 is a diagrammatic representation of an electrochemical microcell of a device according to the invention obtained using the protocol of this example. In this figure, the operating zone consists of the measuring electrode or working electrode (WE), of the conductive polymer bearing the oligonucleotide (Po) deposited onto the counter electrode (CE) and of the capture zone (Zc) formed by the outermost electrode on which the polymer bearing alcohol functions has been deposited (Pm). The entire assembly is produced on the non-wetting active surface (Sa).

### Example 6

### Localized Functionalization of Chip Operating Zones According to the Invention with an Expensive Reagent

In this example, use is made of a system with four electrodes whose surface has been rendered hydrophobic as in Example 5. The hydrophilic barrier and the grafting of the biological molecule are produced with the following protocol:
A) production of the hydrophilic barrier which constitutes the capture zone: the hydrophilic barrier is produced as in Example 4.1.
B) introduction, onto the component, of the electrolyte solution containing the pyrrole, the pyrrole functionalized with an oligonucleotide and the 0.1 M LiClO₄ support electrolyte. The solution is suctioned off, thus leaving a drop of the electrolyte solution well localized on the operating zone (electrochemical microcell), giving the same result as that shown on the right-hand photograph of FIG. 5. Potentiostatic electropolymerization is then carried out on the counter electrode (1 V versus Ag/AgCl/Cl⁻) for 2 seconds. The polypyrrole bearing the oligonucleotide is thus deposited onto the operating zone exclusively.

The device of the invention therefore clearly makes it possible to save on the reagents, in particular when a large surface comprising several independent electrochemical devices distributed over the surface is functionalized, and thus also serves to confine the reagent on the zone of electrodes of a complete chip according to the invention.

It is also possible to thus produce a system in which the wetting band (capture zone) surrounds a set of electrochemical microcells, i.e. several operating zones, for example as in FIG. 2.

### Example 7

### Fabrication of a Box According to the Invention and Operation of this Box

7.1 Fabrication of the Box

A hollow cover of polydimethylsiloxane (PDMS) is fabricated by moulding on a glass mould with a square unit with an overfit of 1 mm.

This hollow cover is hermetically attached to a planar device of the present invention, such as those obtained in the preceding examples, by bonding with adhesive curable by irradiation with ultraviolet rays (Vitralit 6181). The connections for the fluid inlets and outlets are produced by piercing the cover with needles of small diameter. The inlet needle is connected to tubes for transporting fluid and to a syringe full of the liquid of interest. The final assembly is tested so as to detect any possible leaks, given that the liquid must pass only through the connections provided for this purpose.

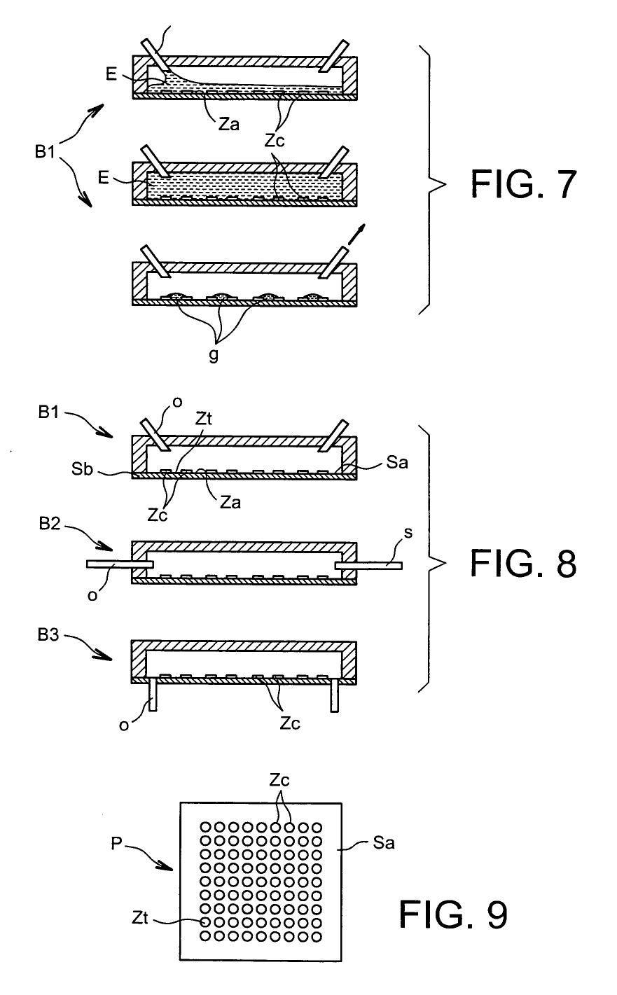

FIG. 7 is a diagrammatic representation of the box as obtained in this example. Other arrangements of the inlet and outlet connections can readily be produced, and FIG. 8 reiterates diagrammatic representations of the boxes which can be obtained according to the protocol described in this example.

In this FIG. 8, B1, B2 and B3 represent three types of boxes according to the invention with inlet (O) and outlet (s) openings placed differently. Sb, Sa, Zc and Zt have the same meaning as in the abovementioned figures. The various elements that constitute the box of the invention are represented in the same way on the three diagrams.

FIG. 9 is a diagrammatic representation viewed from above of a plate P according to the invention which is used to fabricate a box according to the invention. This plate comprises 81 capture zones and corresponding operating zone arranged on a non-wetting active surface in accordance with the present invention.

7.2 Operation of the Box and Results

The operation of the abovementioned boxes is tested. FIG. 7 represents the operation of box B1 of FIG. 8. The liquid of interest E is injected into the box (7a) via one of the openings (o) until it is full (7b), and then withdrawn via the other opening (s). The injection means used is a syringe, and the withdrawal means used is a syringe.

It is not obligatory for the box to be filled, the essential point being that the various capture zones are covered by the liquid of interest.

This example shows that an array of drops (g) well localized on the various capture zones is obtained by virtue of this device in accordance with the present invention.

### REFERENCE LIST

[1] WO 02/16023: Protogene Laboratories Inc.
[2] U.S. Pat. No. 6,040,193: Affymetrix Inc.
[3] WO 99/03684: Eapen Saji et col.
[4] Azek et al., Analytical Biochemistry, 2000, 284, 107-113.
[5] WO 00/36145: Commissariat a l'Energie Atomique [Atomic Energy Commission].
[6] WO 02/090573: Infineon.
[7] Junghoon Lee et al., “Electrowetting and Electrowetting-on-dielectric for microscale liquid handling”, Sensor and Actuators A 95 (2002), 259-268.
[8] J. Cooper et al., “Micromachining Sensor for Electrochemical Measurement in Subnanoliter Volumes”, Anal. Chem. 1997, 69, 253-258.
[9] Mengsu Yang et al., “Covalent Immobilisation of Oligonucleotides on Modified Glass/Silicon Surfaces for Solid-Phase DNA Hybridization and Amplification”, Chemistry Letters 1998, 257-258.
[10] Mila Boncheva et al., “Design of Oligonucleotide Arrays at Interfaces”, Langmuir 1999, 15, 4317-4320.
[11] H. Jansen et al., “The black silicon method: a universal method for determining the parameter setting of a fluorine-based reactive ion etcher in deep silicon trench etching with profile control”, J. Micromech. Microeng. 5 (1995), 115-120.
[12] FR-A-2 818 662.
[13] EP-B-561 722.

1. Operating device comprising:
a substrate comprising an active surface that is substantially non-wetting with respect to a liquid of interest,
at least one zone for the localized capture of a drop of said liquid of interest formed on said active surface,
at least one operating zone arranged with the capture zone so that said capture zone surrounds the operating zone continuously or discontinuously, in such a way that the operating zone is at least partially covered by the drop of the liquid of interest when said drop is captured by said capture zone,
means for supplying the liquid of interest that make it possible to leave a drop of said liquid of interest on said capture zone.

2. Device according to claim 1, in which at least one capture zone has an open or closed shape chosen from an annular shape, a star shape, a rectangular shape, a square shape, a triangular shape, an elliptical shape, or a 4- to 20-sided polygonal shape, and surrounds the at least one operating zone.

3. Device according to claim 1, in which a capture zone for a drop of liquid of interest surrounds several working zones.

4. Device according to claim 1, in which the capture zone is a zone for the chemical, electrical or physical capture of a drop of liquid of interest.

5. Device according to claim 1, in which the capture zone is a hollow in, or a projection on, the active surface making it possible to capture the drop by capillary forces.

6. Device according to claim 1, in which the at least one capture zone is an electrode for capture by wetting.

7. Device according to claim 1, in which the at least one capture zone consists of black silicon.

8. Device according to claim 1, in which the at least one capture zone is an electrode for capture by electrowetting.

9. Device according to claim 6, in which the electrodes captured by wetting consists of a material chosen from the group consisting of the noble metals, of noble metal alloys, of carbon, of graphite, and of ITO, said material being rendered wetting by electrodeposition onto the latter of an electrically conducting polymer to which a chemical function that is wetting with respect to the liquid of interest is attached.

10. Device according to claim 1, in which the capture zone consists of a material rendered wetting by grafting onto the latter of a chemical function that is wetting with respect to the liquid of interest.

11. Device according to claim 10, in which the material is chosen from the group consisting of silicon, silicon oxide, glass, silicon nitride and organic polymers; and of a metal or of a metal alloy.

12. Device according to claim 11, in which the grafting onto the material is carried out by silanization with a silane bearing the wetting chemical function.

13. Device according to claim 6, in which the electrode for capture by wetting is a gold electrode rendered wetting by physisorption of a thiol to which a chemical function that is wetting with respect to the liquid of interest is attached.

14. Device according to claim 9, in which, since the liquid of interest is aqueous, the chemical function that is wetting with respect to the liquid of interest is chosen from the group consisting of an alcohol, alkoxide, carboxylic acid, carboxylate, sulphonic acid, sulphonate, oxiamine, hydrazine, amine and ammonium function.

15. Device according to claim 1, in which, since the liquid of interest is aqueous, the at least one capture zone is a hydrophilic zone and the substantially non-wetting active surface is hydrophobic.

16. Device according to claim 1, in which the capture zone and the operating zone(s) arranged with it can be placed in a hollow or on a projection relative to the active surface.

17. Device according to claim 1, in which the at least one operating zone is a zone of electrical and/or chemical interaction with said drop of liquid of interest captured.

18. Device according to claim 17, in which the at least one operating zone is an electrochemical microcell.

19. Device according to claim 1, in which the at least one operating zone is a zone for detection of at least one chemical or biological species that may be present in the drop of liquid of interest when it is captured.

20. Device according to claim 1, in which the at least one operating zone is a zone functionalized with a probe intended to interact with a target that may be present in the drop of liquid of interest when it is captured.

21. Device according to claim 6, in which the electrode for capture of a drop of liquid of interest by wetting is also used as an electrode for the operation of the electrochemical microcell of the operating zone.

22. Device according to claim 17, in which the electrode for capture of a drop of liquid of interest by wetting is also used as an electrode for the operation of the electrochemical microcell of the operating zone, and in which said electrode is functionalized with a probe intended to interact with a target that may be present in the drop of liquid of interest.

23. Device according to claim 22, in which the probe is attached to the electrically conducting polymer bearing a wetting function.

24. Device according to claim 9, in which the electrically conducting polymer is chosen from the group consisting of polypyrrole, polyaniline, polyazulene, a polythiophene, a polyindole, a polyfuran and a polyfluorene.

25. Device according to claim 22, in which the probe is chosen from the group consisting of an enzyme, an enzyme substrate, an oligonucleotide, an oligonucleoside, a protein, a membrane receptor of a eukaryotic or prokaryotic cell, an antibody, an antigen, a hormone, a metabolite of a living organism, a toxin of a living organism, a polynucleotide, a polynucleoside and a complementary DNA.

26. Device according to claim 1, in which the at least one operating zone is a sensor chosen from the group consisting of optical, electrical, magnetic, electrostatic, mechanical, thermal and chemical sensors.

27. Device according to claim 1, in which the at least one operating zone is an actuator chosen from the group consisting of optical, electrical, magnetic, electrostatic, mechanical, thermal and chemical actuators.

28. Device according to claim 1, in which the at least one operating zone is a zone that is substantially non-wetting with respect to the liquid of interest.

29. Device according to claim 1, in which the active surface is a surface consisting of a material chosen from the group consisting of silicon; silicon oxide; glass; silicon nitride; an organic polymer; a metal or a metal alloy.

30. Operating plate comprising several identical or different operating devices according to claim 1.

31. Operating plate according to claim 30, in which the operating devices form an array.

32. Device according claim 1, or plate according to claim 30, in which the means for leaving a drop of liquid of interest on said localized capture zone is a dispenser of a drop of liquid of interest per capture zone.

33. Operating box comprising:
a container comprising means for the introduction of a liquid of interest into the container and for the withdrawal of liquid of interest from the container,
an operating device according to claim 1, or a plate according to claim 30, placed in said container,
the means for the introduction and for the withdrawal of the liquid of interest into and from the container being arranged in such a way that, when the liquid of interest is introduced into the container, it covers the at least one capture zone(s), and then, when the liquid of interest is withdrawn from the container, a drop of liquid of interest remains captive by virtue of said capture zone.

34. Operating box according to claim 33, in which the means for the extraction of the liquid of interest from the container consist of a pump for injection of a gaseous fluid via an inlet opening so as to withdraw the liquid of interest by driving it from the container via an outlet opening.

35. Operating box according to claim 34, in which the pump for injection of the gaseous fluid via the inlet opening of the container comprises a device for saturating the gaseous fluid injected with vapour of the liquid of interest.

36. Operating box according to claim 33, in which the means for the withdrawal of liquid of interest from the container consist of a suction pump placed so as to withdraw the liquid of interest from the container by suctioning it.

37. System comprising one or more operating device(s) according to claim 1, or a plate according to claim 30.

38. System comprising an operating box according to claim 33.

39. Biological chip comprising an operating device according to claim 1, or a plate according to claim 30.

40. Biological chip according to claim 39, said chip being chosen from the group consisting of nucleic acid chips, antibody chips, antigen chips, protein chips and cell chips.

41. Box comprising a biological chip according to claim 39.

42. Method for the fabrication of a device according to claim 1, said method comprising the following steps:
providing a substrate comprising a surface chosen to become the active surface,
structuring the chosen surface of the substrate in order to form thereon an operating zone,
applying a treatment to the chosen surface in order to render it substantially non-wetting with respect to the liquid of interest for which the device is intended, and
structuring the chosen surface in order to form a capture zone for a drop of liquid of interest,
the steps consisting in structuring the surface so as to form an operating zone and in structuring the surface so as to form the capture zone being carried out such that the operating zone is arranged with the capture zone so that the capture zone surrounds the operating zone continuously or discontinuously in such a way that, when the capture zone captures a drop of liquid of interest, the operating zone is at least partially covered by said drop.
